(19) United States
(12) Patent Application Publication
(10) Pub. No.: US 2025/0116803 A1
(43) Pub. Date: Apr. 10, 2025

(54) OPTICAL FILTER AND IMAGING APPARATUS

(71) Applicant: AGC Inc., Tokyo (JP)

(72) Inventors: Kazuhiko SHIONO, Fukushima (JP); Yayoi YAMAMORI, Fukushima (JP); Takahiro SAKAGAMI, Shizuoka (JP); Takashi NAGATA, Shizuoka (JP); Katsushi KAMIJYO, Shizuoka (JP)

(73) Assignee: AGC Inc., Tokyo (JP)

(21) Appl. No.: 18/982,967

(22) Filed: Dec. 16, 2024

Related U.S. Application Data
(63) Continuation of application No. PCT/JP2023/022114, filed on Jun. 14, 2023.

(30) Foreign Application Priority Data
Jun. 24, 2022 (JP) 2022-102154

(51) Int. Cl. G02B 5/22; G02B 1/02; G02B 1/115

(52) U.S. Cl. CPC G02B 5/226; G02B 1/02; G02B 1/115; G02B 5/223

(57) ABSTRACT

An optical filter includes a glass substrate having a first main surface, a second main surface opposite the first main surface, and an end surface connecting the first and second main surfaces, the glass substrate being a phosphate glass containing an absorbent, and a first antireflection layer disposed directly or indirectly on the first main surface of the glass substrate, wherein the first main surface of the glass substrate is coated with a first inorganic film, and a second inorganic film is provided directly or indirectly on the second main surface of the glass substrate, with the end surface being coated with a third inorganic film, and wherein the first inorganic film is a film that is closest to the glass substrate among films constituting the first antireflection layer, or a film that is different from a film composed of a plurality of films constituting the first antireflection layer.

### CROSS-REFERENCE TO RELATED APPLICATIONS

This application is a continuation application of International Application No. PCT/JP2023/022114, filed on Jun. 14, 2023, and designated the U.S., which is based upon and claims priority to Japanese Patent Application No. 2022-102154, filed on Jun. 24, 2022. The entire contents of these applications are incorporated herein by reference.

### BACKGROUND OF THE INVENTION

### 1. Field of the Invention

The disclosures herein relate to optical filters and imaging apparatuses.

### 2. Description of the Related Art

Imaging apparatuses such as vehicle-mounted cameras and smartphone cameras are provided with solid-state imaging devices (CCD, CMOS, etc.). However, the solid-state imaging device shows higher sensitivity to infrared light than human visual sense. Therefore, in order to bring an image captured by the solid-state imaging device closer to human visual perception, an optical filter is further installed in the imaging apparatus.

A high-precision optical filter is required to have (1) high transmittance in a visible light region, (2) high light shielding performance in an infrared light region, and (3) an optical property that does not change with an incidence angle of light.

In order to satisfy these properties, Patent Literature (PTL) 1 describes an optical filter having a CuO-containing fluorophosphate glass substrate. The CuO-containing fluorophosphate glass substrate has a function of absorbing infrared rays to some extent. Therefore, by combining a CuO-containing fluorophosphate glass substrate, a dye-containing layer, and a dielectric multilayer film, the optical filter having effects (1) to (3) described above can be provided.

However, the inventors of the present application have recognized that the effects (2) and (3) described above are not sufficient even in the optical filter described in PTL 1.

In particular, the optical filter for a camera mounted on an electronic device such as a smartphone has increasingly been required to be more power saving in recent years. As such a power saving optical filter progresses, a problem of angular dependence of optical properties is expected to become more prominent in the future.

An object of the present invention is to provide the optical filter having significantly high light shielding performance in the infrared region and significantly reduced angular dependence of optical properties.

### CITATION LIST

### Patent Literature

[PTL 1] International Publication 2014/030628

### SUMMARY OF THE INVENTION

According to an embodiment, an optical filter including a glass substrate having a first main surface, a second main surface opposite the first main surface, and an end surface connecting the first and second main surfaces, the glass substrate being a phosphate glass containing an absorbent, and a first antireflection layer disposed directly or indirectly on the first main surface of the glass substrate, wherein the first main surface of the glass substrate is coated with a first inorganic film, and a second inorganic film is provided directly or indirectly on the second main surface of the glass substrate, with the end surface being coated with a third inorganic film, and wherein the first inorganic film is a film that is closest to the glass substrate among films constituting the first antireflection layer, or a film that is different from a film composed of a plurality of films constituting the first antireflection layer, is provided.

According to embodiments of the present invention, the optical filter can be provided which the significantly high has light shielding performance in the infrared region and the angular dependence of optical properties is significantly reduced.

### BRIEF DESCRIPTION OF THE DRAWINGS

FIG. 1 is a drawing illustrating a comparison of typical optical properties between a fluorophosphate glass (a) and a phosphate glass (b) containing CuO;

FIG. 2 is a cross-sectional view schematically illustrating a configuration example of an optical filter according to one embodiment of the present invention;

FIG. 3 is a cross-sectional view schematically illustrating a configuration example of an optical filter according to another embodiment of the present invention;

FIG. 4 is a cross-sectional view is schematically illustrating a configuration example of an optical filter according to yet another embodiment of the present invention;

FIG. 5 is a cross-sectional view schematically illustrating one configuration of an end surface of a glass substrate included in the optical filter according to one embodiment of the present invention;

FIG. 6 is a cross-sectional view schematically illustrating another configuration of the end surface of the glass substrate included in the optical filter according to one embodiment of the present invention;

FIG. 7 is drawing a schematically illustrating an example of optical properties of the glass substrate included in the optical filter according to one embodiment of the present invention;

FIG. 8 is a drawing schematically illustrating an example of optical properties of a resin layer included in the optical filter according to one embodiment of the present invention;

FIG. 9 drawing schematically is a illustrating an example of optical properties of the optical filter according to one embodiment of the present invention;

FIG. 10 is a flow chart schematically illustrating an example of a method of manufacturing the optical filter according to one embodiment of the present invention;

FIG. 11 is a drawing schematically illustrating an example of a transmittance profile obtained in the optical filter according to one embodiment of the present invention;

FIG. 12 is a drawing schematically illustrating an example of a reflectance profile obtained in the optical filter according to one embodiment of the present invention; and

FIG. 13 is a is drawing schematically illustrating an example of a transmittance profile obtained in the optical filter according to another embodiment of the present invention.

### DESCRIPTION OF THE PREFERRED EMBODIMENTS

In the following, one embodiment of the present invention will be described with reference to the accompanying drawings.

As described above, the effects (2) and (3) described above are still insufficient in related optical filters. Therefore, there is a possibility that related optical filters cannot sufficiently prevent light leakage in the infrared region and/or a phenomenon that the optical properties change depending on the incidence angle of light (hereinafter, referred to as an “angular dependence problem”).

In particular, it is expected that the “angular dependence problem” will become more pronounced in the future as optical filters become further power saving.

Against this background, the inventors of the present application have earnestly studied and developed a structure of an optical filter capable of further enhancing the effects (2) and (3).

The inventors of the present application have found that absorption in the infrared region can be further enhanced when phosphate glass is used instead of fluorophosphate glass as the glass substrate containing an absorbent, and that the “angular dependence problem” can be solved by discontinuing use of an infrared cut film.

However, phosphate glass has a property of easily eluting when it comes into contact with water. Therefore, when phosphate glass is used as the glass substrate of the optical filter, a problem may arise in terms of durability.

The inventors of the present invention continued to examine such a newly generated durability problem, and as a result, it was found that the problem of elution of the glass can be solved by adopting a structure in which the phosphate glass is not exposed to the external environment in the optical filter.

Therefore, according to one embodiment, an optical filter including a glass substrate having a first main surface, a second main surface opposite the first main surface, and an end surface connecting the first and second main surfaces, the glass substrate being a phosphate glass containing an absorbent, and a first antireflection layer disposed directly or indirectly on the first main surface of the glass substrate, wherein the first main surface of the glass substrate is coated with a first inorganic film, and a second inorganic film is provided directly or indirectly on the second main surface of the glass substrate, with the end surface being coated with a third inorganic film, and wherein the first inorganic film is a film that is closest to the glass substrate among films constituting the first antireflection layer, or film is a that different from a film composed of a plurality of films constituting the first antireflection layer, is provided.

In the optical filter according to one embodiment of the present invention, an infrared cut film is not used.

Therefore, in the optical filter according to one embodiment of the present invention, the “angular dependence problem” hardly occurs, and for example, the optical characteristics do not change much even if the incidence angle of light changes from 0° to 50°.

Further, in one embodiment of the present invention, phosphate glass is used as the glass for an absorbent-containing glass substrate.

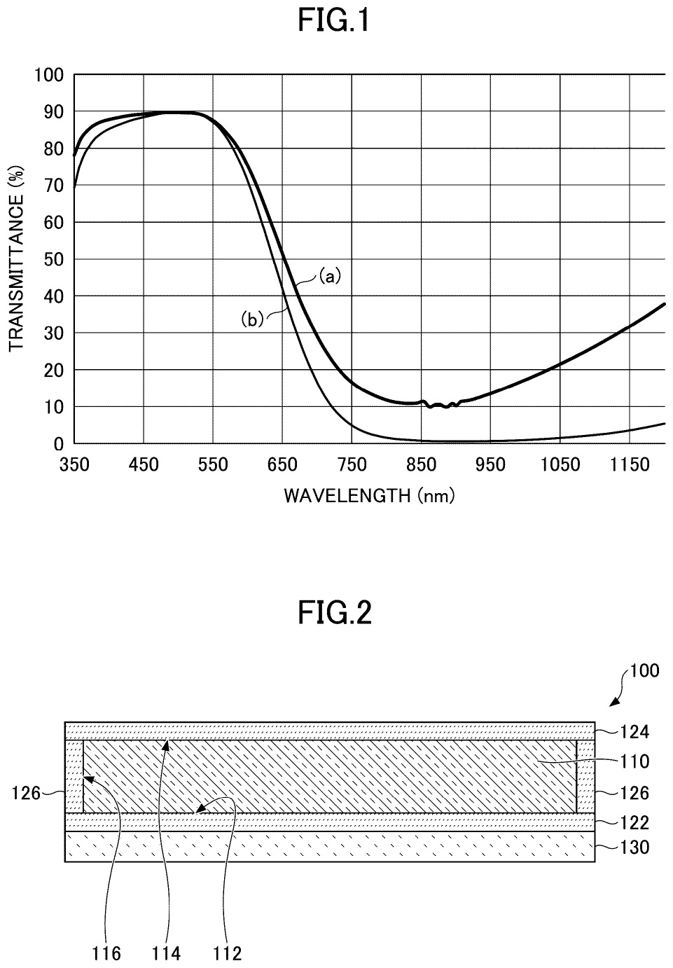

FIG. 1 shows typical optical properties of the fluorophosphate glass and the phosphate glass containing absorbent (CuO). In FIG. 1, a horizontal axis represents a wavelength of light, and a vertical axis represents transmittance. In FIG. 1, (a) represents the transmittance of the absorbent-containing fluorophosphate glass, and (b) represents the transmittance of the absorbent-containing phosphate glass.

As shown in FIG. 1, the absorbent-containing phosphate glass has transmittance equal to that of the absorbent-containing fluorophosphate glass in a wavelength range from 450 to 600 nm. Therefore, even if phosphate glass is used instead of fluorophosphate glass as the glass substrate of the optical filter, a high transmittance can be maintained in the visible light region.

Moreover, as shown in FIG. 1, the absorbent-containing phosphate glass has a sufficiently low transmittance compared with the absorbent-containing fluorophosphate glass in the wavelength range higher than 750 nm.

Therefore, when absorbent-containing phosphate glass is used as the glass substrate of the optical filter, the light shielding property in the infrared region can be significantly enhanced in combination with the antireflection layer without using an infrared cut film.

Furthermore, in one embodiment of the present invention, the glass substrate is arranged in the optical filter so as not to produce an exposed surface with respect to the outside.

That is, the glass substrate is arranged such that the first main surface is covered with the first inorganic film, the second inorganic film is provided directly or indirectly on the second main surface, and the end surface is covered with the third inorganic film.

Here, the first inorganic film may be a film nearest to the glass substrate among the films constituting the first antireflection layer. Alternatively, the first inorganic film may be a film different from the film constituting the first antireflection layer.

The second main surface may be directly coated with the second inorganic film.

Thus, in one embodiment of the present invention, the glass substrate is coated with the inorganic film at its periphery. Therefore, even if the glass substrate is made of absorbent-containing phosphate glass, the problem that the glass is eluted by moisture in the environment can be significantly prevented.

As a result, in one embodiment of the present invention, it is possible to provide an optical filter having a significantly high light shielding property in the infrared region and a significantly reduced angular dependence of optical characteristics.

### (Optical Filter According to One Embodiment of the Present Invention)

An optical filter according to one embodiment of the present invention will be described below with reference to FIG. 2.

FIG. 2 schematically shows a cross-sectional view of a configuration of the optical filter according to one embodiment of the present invention.

As shown in FIG. 2, an optical filter (hereinafter, referred to as “first optical filter”) 100 according to one embodiment of the present invention has a glass substrate 110 and a first antireflection layer 130.

The glass substrate 110 has a first main surface 112 and a second main surface 114 opposite each other, and an end surface 116 between the both main surfaces. The first antireflection layer 130 is disposed directly or indirectly on the first main surface 112 of the glass substrate 110.

The glass substrate 110 is composed of phosphate glass containing an absorbent.

In the present application, the phosphate glass means glass containing 50 mass % or more of P₂O₅ on an oxide basis.

The first antireflection layer 130 is composed of a dielectric multilayer film.

The first optical filter 100 further has a first inorganic film 122, a second inorganic film 124, and a third inorganic film 126.

The first inorganic film 122 is arranged so as to cover the first main surface 112 of the glass substrate 110, and the second inorganic film 124 is arranged so as to cover the second main surface 114 of the glass substrate 110. The third inorganic film 126 is disposed so as to cover the end surface 116 of the glass substrate 110.

When the glass substrate 110 composed of phosphate glass comes into contact with moisture in the environment, it tends to elute relatively easily.

However, in the first optical filter 100, the glass substrate 110 is provided in a state in which all surfaces are covered with an inorganic film (first inorganic film 122, second inorganic film 124, and third inorganic film 126). Therefore, in the first optical filter 100, the problem that the glass substrate 110 reacts with moisture in the outside and elutes can be significantly prevented.

Moreover, the first optical filter 100 does not use an infrared cut film, which is a factor of the angular dependence problem. Therefore, in the first optical filter 100, the angular dependence problem can be significantly prevented.

As a result, the first optical filter 100 has a significantly high light shielding property in the infrared region, and the angular dependence of the optical characteristics can be significantly reduced.

In the example shown in FIG. 2, the first inorganic film 122 and the first antireflection layer 130 are provided directly or indirectly on the first main surface 112 of the glass substrate 110.

However, in the first optical filter 100, the first inorganic film 122 may be a film closest to the glass substrate 110 among the films constituting the first antireflection layer 130. In this case, the first inorganic film 122 may be visually omitted.

### (Optical Filter According to Another Embodiment of the Present Invention)

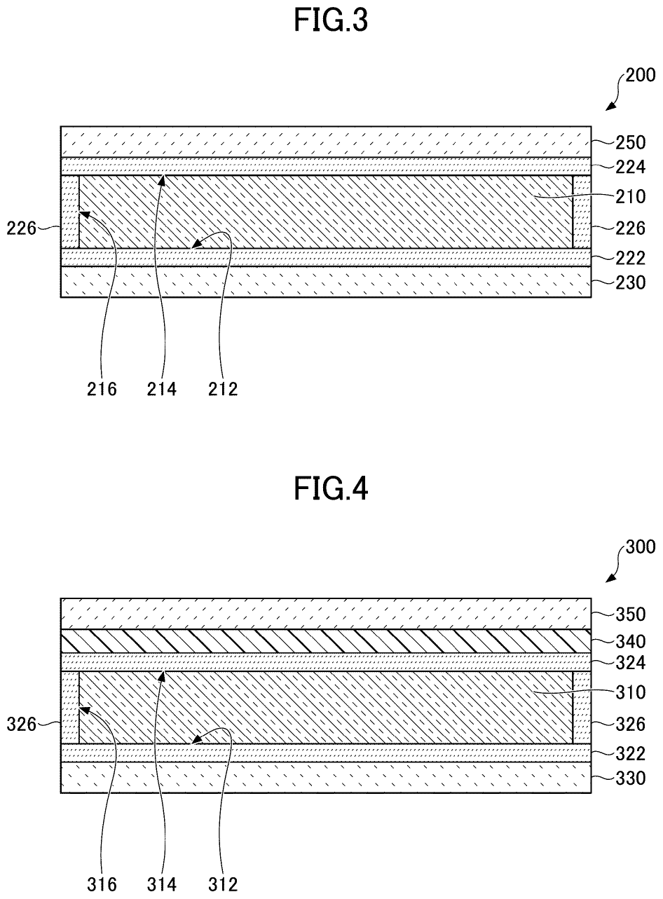

Next, an optical filter according to another embodiment of the present invention will be described with reference to FIG. 3.

FIG. 3 schematically shows a cross-sectional view of a configuration of an optical filter according to another embodiment (hereinafter, referred to as “second optical filter”) of the present invention.

As shown in FIG. 3, the second optical filter 200 has the same configuration as the first optical filter 100 described above. Accordingly, in FIG. 3, reference numerals obtained by adding 100 to the reference numerals shown in FIG. 2 are used for the members included in the first optical filter 100 and the corresponding members.

For example, as shown in FIG. 3, the second optical filter 200 includes a glass substrate 210, first to third inorganic films 222 to 226, and a first antireflection layer 230.

However, in the second optical filter 200, unlike the first optical filter 100, the second antireflection layer 250 is provided on the second inorganic film 224.

Also in the second optical filter 200, the first main surface 212 of the glass substrate 210 is covered with the first inorganic film 222, the second main surface 214 is covered with the second inorganic film 224, and the end surface 216 is covered with the third inorganic film 226.

Therefore, also in the second optical filter 200, the problem that the glass substrate 210 composed of phosphate glass reacts with moisture in the outside and elutes can be significantly prevented.

Moreover, the second optical filter 200 does not use an infrared cut film, which is a factor of the angular dependence problem. Therefore, also in the second optical filter 200, the angular dependence problem can be significantly prevented.

As a result, the second optical filter 200 has a significantly high light shielding property in the infrared region, and the angular dependence of the optical characteristics can be significantly reduced.

In the example shown in FIG. 3, the second inorganic film 224 and the second antireflection layer 250 are respectively provided directly or indirectly on the second main surface 214 of the glass substrate 210.

However, in the second optical filter 200, the second inorganic film 224 may be the film closest substrate 210 among the films to the glass constituting the second antireflection layer 250. In this case, the second inorganic film 224 may be visually omitted.

As described above, the first inorganic film 222 may be the film closest to the glass substrate 210 among the films constituting the first antireflection layer 230.

### (Optical Filter According to Yet Another Embodiment of the Present Invention)

Next, an optical filter according to yet another embodiment of the present invention will be described with reference to FIG. 4.

FIG. 4 schematically shows a cross-sectional view of a configuration of an optical filter according to yet another embodiment (hereinafter, referred to as “third optical filter”) of the present invention.

As shown in FIG. 4, the third optical filter 300 has the same configuration as the second optical filter 200 described above. Accordingly, in FIG. 4, the reference numerals obtained by adding 100 to the reference numerals shown in FIG. 4 are used for the members corresponding to the members included in the second optical filter 200.

For example, as shown in FIG. 4, the third optical filter 300 includes a glass substrate 310, first to third inorganic films 322 to 326, a first antireflection layer 330, and a second antireflection layer 350.

However, in the third optical filter 300, unlike the second optical filter 200, a resin layer 340 is provided between the second inorganic film 324 and the second antireflection layer 350.

The resin layer 340 is made of a resin containing dye. Details of the resin layer 340 will be described later.

Also in the third optical filter 300, the first main surface 312 of the glass substrate 310 is covered with the first inorganic film 322, the second main surface 314 is covered with the second inorganic film 324, and the end surface 316 is covered with the third inorganic film 326.

Therefore, also in the third optical filter 300, the problem that the glass substrate 310 composed of phosphate glass reacts with moisture in the outside and elutes can be significantly prevented.

Moreover, the third optical filter 300 does not use an infrared cut film, which is a factor of the angular dependence problem. Therefore, also in the third optical filter 300, the angular dependence problem can be significantly prevented.

As a result, the third optical filter 300 has a significantly high light shielding property in the infrared region, and the angular dependence of the optical characteristics can be significantly reduced.

In the example shown in FIG. 4, the first inorganic film 322 and the first antireflection layer 330 are respectively provided directly or indirectly on the first main surface 312 of the glass substrate 310.

However, as described above, in the third optical filter 300, the first inorganic film 322 may be the film closest to the glass substrate 310 among the films constituting the first antireflection layer 330. In this case, the first inorganic film 322 may be visually omitted.

### (Each Member Included in Optical Filter According to One Embodiment of the Present Invention)

Next, each member constituting the optical filter according to one embodiment of the present invention will be described in more detail. Here, for the sake of clarity, the constituent members will be described with reference to the third optical filter 300 shown in FIG. 4. Accordingly, reference numerals shown in FIG. 4 will be used to denote each member.

### (Glass Substrate 310)

Hereinafter, a glass substrate 310 used for an optical filter according to one embodiment of the present invention will be described. In the following description, unless otherwise specified, the content of each component and the total content represent a value in a percentage by mass on an oxide basis.

The glass substrate 310 is composed of phosphate glass containing an absorbent.

The absorbent contained in the glass substrate 310 is a metal oxide and may be, for example, CuO.

The absorbent may be contained in a range of 4% to 20% in a percentage by mass on an oxide basis relative to the entirety of the glass substrate 310.

For example, the glass substrate 310 may include in a percentage by mass on an oxide basis:
50% to 80% P₂O₅;
5% to 20% Al₂O₃;
4% to 20% CuO;
0.5% to 15% R(1) ₂O, wherein R(1) is at least one component selected from the group consisting of Li, Na, K, Rb, and Cs; and
0% to 15% R(2)O, wherein R(2) is at least one component selected from the group consisting of Ca, Mg, Ba, Sr, and Zn.

P₂O₅ is a main component for forming the glass and is a component for enhancing near infrared ray cutting property. When the content of P₂O₅ is 50% or more, the effect can be sufficiently obtained, and when it is 80% or less, problems such as glass is unstable and weather resistance deteriorating are unlikely to occur. Therefore, the content of P₂O₅ is preferably 50-80%, more preferably 52-78%, still more preferably 54-77%, further more preferably 56-76%, and most preferably 60-75%.

Al₂O₃ is a main component for forming the glass and is a component for enhancing the strength of glass. When the content of Al₂O₃ is 5% or more, the effect can be sufficiently obtained, and when it is 20% or less, problems such as glass is unstable and near infrared ray cutting property deteriorating are unlikely to occur. Therefore, the content of Al₂O₃ is preferably 5-20%, more preferably 6-18%, still more preferably 7-17%, further more preferably 8-16%, and most preferably 9-13%. When the content of Al₂O₃ is 9% or more, the weather resistance of glass can be enhanced.

R(1) ₂O is a component for lowering the melting temperature of glass, lowering the liquid phase temperature of glass, stabilizing glass, and the like. When the content of R(1) ₂O is 0.5% or more, the effect can be sufficiently obtained, and when it is 20% or less, it is preferable because the glass is unlikely to be unstable. Therefore, the total amount of R(1) ₂O is preferably 0.5-20%, more preferably 1-20%, still more preferably 2-20%, further more preferably 3-20%, and most preferably 4-20%.

Li₂O is a component for lowering the melting temperature of glass, lowering the liquid phase temperature of glass, stabilizing glass, and the like. The content of Li₂O is preferably 0-15%. When the content of Li₂O is 15% or less, it is preferable because problems such as instability of glass and deterioration of near-infrared cutting property are unlikely to occur. The content of Li₂O is more preferably 0-8%, still more preferably 0-7%, further more preferably 0-6%, and most preferably substantially free of Li₂O.

In the present application, substantially free of the specific component means that it is intentionally not added, and does not exclude the content of the specific component to a degree that it is unavoidably mixed from the raw material or the like and does not affect the intended characteristics.

Na₂O is a component for lowering the melting temperature of glass, lowering the liquid phase temperature of glass, stabilizing glass, and the like. The content of Na₂O is preferably 0-15%. The content of Na₂O is preferably 15% or less because the glass is unlikely to be unstable. The content of Na₂O is more preferably 0.5-14%, still more preferably 1-13%, and further more preferably 2-13%.

K₂O is a component having an effect of lowering the melting temperature of the glass, lowering the liquid phase temperature of the glass, etc. The content of K₂O is preferably 0-15%. A content of K₂O of 15% or less is preferable because the glass is unlikely to be unstable. The content of K₂O is more preferably 0.5-14%, still more preferably 1-13%, and further more preferably 2-13%.

Rb₂O is a component having effects such as lowering the melting temperature of the glass and lowering the liquid phase temperature of the glass. The content of Rb₂O is preferably 0-15%. The content of Rb₂O is preferably 15% or less because the glass is unlikely to be unstable. The content of Rb₂O is more preferably 0.5-14%, still more preferably 1-13%, and further more preferably 2-13%.

Cs₂O is a component having effects such as lowering the melting temperature of the glass and lowering the liquid phase temperature of the glass. The content of Cs₂O is preferably 0-15%. If the content of Cs₂O is 15% or less, it is preferable because the glass is unlikely to be unstable. The content of Cs₂O is more preferably 0.5-14%, still more preferably 1-13%, and further more preferably 2-13%.

R(2)O is a component for lowering the melting temperature of the glass, lowering the liquid phase temperature of the glass, stabilizing the glass, and increasing the strength of the glass. The total amount of R(2)O is preferably 0-15%. When the total amount of R(2)O is 15% or less, problems such as instability of the glass, reduction of near-infrared ray cutting property, reduction of short-wavelength infrared ray transmission, and reduction of strength of the glass are not likely to occur. The total amount of R(2)O is more preferably 0-13%, still more preferably 0-11%, further more preferably 0-9%, and further more preferably 0-8%.

CuO is a component for cutting near-infrared rays. When the content of CuO is 4% or more, the effect is sufficiently obtained. When the content is 20% or less, it is preferable because problems such as a decrease in transmittance in the visible light region and a decrease in transmittance in the short-wavelength infrared region hardly occur. The content of CuO is more preferably 4-19.5%, still more preferably 5-19%, still more preferably 6-18.5%, and still more preferably over 7%. In particular, when the glass substantially contains no divalent cations other than Cu, the CuO content is over 7%, so that the cutting property of near-infrared rays and the transmittance of short-wavelength infrared rays can be further enhanced. The content of CuO is most preferably 7-18% (but not 7%).

The glass substrate 310 preferably contains substantially no divalent cations other than Cu. The reason will be described below.

When the glass of the present embodiment contains CuO, light in a near-infrared region is cut off by the optical absorption of Cu²⁺ ions. The optical absorption is caused by the electronic transition between the d orbitals of Cu²⁺ ions split by an electric field of O²⁻ ions. Splitting of the d orbitals is promoted when symmetry of O²⁻ ions around Cu²⁺ ions decreases. For example, when cations exist around O²⁻ ions, O²⁻ ions are attracted by an electric field of cations, and the symmetry of O²⁻ ions decreases. As a result, the splitting of d orbitals is promoted, and the optical absorption is generated by the electronic transition between the split d orbitals, which weakens the optical absorption in the near-infrared region and enhances the optical absorption in the short-wavelength infrared region. Since electric field strength of cations increases with a valence of ions, addition of oxides containing divalent cations other than Cu in the glass may reduce the near-infrared cutoff and the transmittance of short-wavelength infrared rays.

CaO is a component for lowering the melting temperature of glass, lowering the liquid phase temperature of glass, stabilizing glass, and increasing the strength of glass. The content of Cao is preferably 0-10%. When the content of Cao is 10% or less, it is preferable because problems such as instability of glass, lowering of near-infrared ray cutting property, and lowering of short-wavelength infrared ray transmission are not likely to occur. It is more preferably 0-8%, still more preferably 0-6%, and further more preferably 0-5%. Most preferably, it is substantially free of CaO.

MgO is a component for lowering the melting temperature of glass, lowering the liquid phase glass, temperature of stabilizing glass, and increasing the strength of glass. The content of MgO is preferably 0-15%. When the content of MgO is 15% or less, it is preferable because problems such as instability of glass, lowering of near-infrared ray cutting property, and lowering of short-wavelength infrared ray transmission are unlikely to occur. It is more preferably 0-13%, still more preferably 0-10%, and further more preferably 0-9%. Most preferably it is substantially free of MgO.

BaO is a component for lowering the melting temperature of lowering the liquid phase temperature of glass, stabilizing glass, and the like. The content of BaO is preferably 0.1-10%. When the content of BaO is 10% or less, it is preferable because problems such as instability of glass, lowering of near-infrared ray cutting property, and lowering of short-wavelength infrared ray transmission are unlikely to occur. It is more preferably 0-8%, still more preferably 0-6%, and further more preferably 0-5%. Most preferably, it is substantially free of BaO.

SrO is a component for lowering the melting temperature of glass, lowering the liquid phase temperature of glass, stabilizing glass, and the like. The content of SrO is preferably 0-10%. When the content of SrO is 10% or less, problems such as instability of glass, reduction of near-infrared ray cutting property, and reduction of short-wavelength infrared ray transmission are not likely to occur. It is more preferably 0-8%, and still more preferably 0-7%. Most preferably, it is substantially free of SrO.

ZnO is a component for lowering the melting temperature of glass, lowering the liquid phase temperature of glass, and the like. The content of ZnO is preferably 0-15%. When the content of ZnO is 15% or less, problems such as deterioration of fusibility of glass, reduction of near-infrared ray cutting property, and reduction of short-wavelength infrared ray transmission are not likely to occur. It is more preferably 0-13%, still more preferably 0-10%, further more preferably 0-9%. Most preferably, it is substantially free of ZnO.

The content of B₂O₃ may be 10% or less in order to stabilize the glass. If the content of B₂O₃ is 10% or less, it is preferable because problems such as deterioration of weatherability of the glass, reduction of the near-infrared ray cutting property, and reduction of the short-wavelength infrared ray transmission are unlikely to occur. It is preferably 9% or less, more preferably 8% or less, still more preferably 7% or less, further more preferably 6% or less, and most preferably substantially free of B₂O₃.

Although F is an effective component for improving the weatherability of the glass substrate 310, it is preferable that F is substantially not contained because it is an environmental load material and may reduce the near-infrared ray cutting property.

In order to improve the weatherability of the glass substrate 310, SiO₂, GeO₂, ZrO₂, SnO₂, TiO₂, CeO₂, WO₃, Y₂O₃, La₂O₃, Gd₂O₃, Yb₂O₃, and Nb₂O₅ may be contained in a range of 5% or less. If the content of these components is 5% or less, it is preferable because problems such as a decrease in the near-infrared ray cutting property and a decrease in the short-wavelength infrared ray transmission are unlikely to occur. It is preferably 4% or less, more preferably 3% or less, still more preferably 2% or less, and further more preferably 1% or less.

Fe₂O₃, Cr₂O₃, Bi₂O₃, NiO, V₂O₅, MOO₃, MnO₂, and CoO are all components that, when present in the glass, reduce the visible transmittance. Therefore, these components are preferably substantially not contained in the glass.

The glass substrate 310 preferably has a coefficient of thermal expansion in the range of 30 to 300° C. of 60×10⁻⁷ to 180×10⁻⁷/° C.

The glass substrate 310 may have a thickness in the range of, for example, 0.1 to 3 mm.

A shape of the glass substrate 310 is not particularly limited. The first main surface 312 and the second main surface 314 of the glass substrate 310 may be rectangular or elliptical (including circular).

When the first main surface 312 and second main surface 314 are rectangular, the glass substrate 310 has a plurality of end surfaces 316. Additionally, when the first main surface 312 and second main surface 314 are circular, the glass substrate 310 has a single end surface 316.

The shape of the end surface 316 is not particularly limited. For example, the end surface 316 may have a shape extending in a direction substantially perpendicular to the first main surface 312 and the second main surface 314, or may have any other shape. For example, the end surface 316 of the glass substrate 310 may have an inclined portion with respect to a normal line of the first main surface 312 and/or the normal line of the second main surface 314.

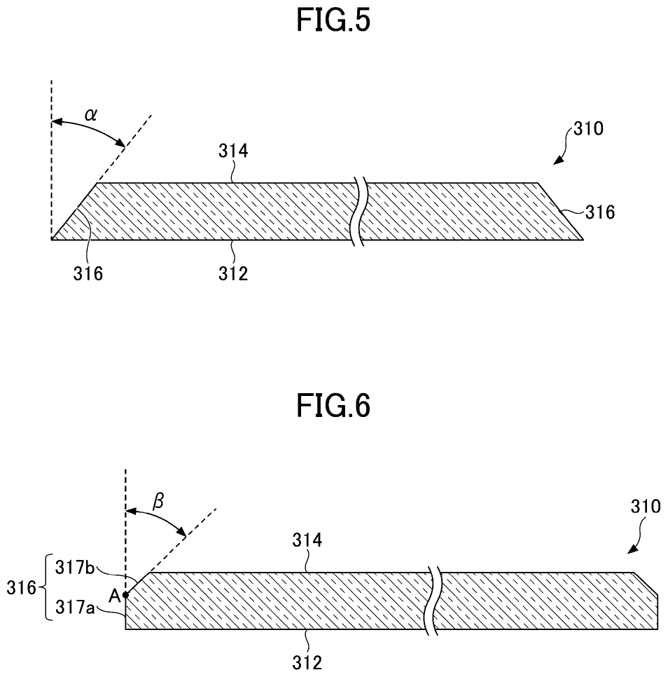

FIG. 5 schematically shows one configuration of the end surface 316 of the glass substrate 310.

As shown in FIG. 5, in the glass substrate 310, the end surface 316 has a shape inclined with respect to the thickness direction (hereinafter, also referred to as “normal to the first major surface”) of the glass substrate 310. As a result, the angle formed by the end surface 316 and the first main surface 312 is an acute angle, and the angle formed by the end surface 316 and the second main surface 314 is an obtuse angle.

Alternatively, the end surface 316 may have a shape such that the angle formed by the end surface 316 and the first main surface 312 is obtuse and the angle formed by the end surface 316 and the second main surface 314 is acute.

When such an end surface 316 inclined with respect to one main surface is used, it is easy to dispose the third inorganic film 326 on the end surface 316.

In the configuration example shown in FIG. 5, inclination angle α (0<α<90°) of the end surface 316 may be in a range of, for example, 0.3° to 20°.

Note that the shape of the end surface 316 shown in FIG. 5 is merely an example, and the end surface 316 may have another configuration.

FIG. 6 schematically shows another configuration of the end surface 316 of the glass substrate 310.

As shown in FIG. 6, in this example, the end surface 316 has a first portion 317a and a second portion 317b.

The first portion 317a extends from the first main surface 312 of the glass substrate 310 to a point A in a direction parallel to the normal line of the first main surface 312. Additionally, the second portion 317b extends from the point A to the second main surface 314 of the glass substrate 310 at an angle β inclined with respect to the normal line of the first main surface 312.

A distance from the first main surface 312 to the point A may be in a range of 0.2t to 0.8t, where t refers to the thickness of the glass substrate 310. The angle β (0≤α<90°) may vary depending on the distance from the first main surface 312 to the point A, but may be in a range of 20° to 60°, for example.

In addition, various shapes can be assumed as the form of the end surface 316 of the glass substrate 310.

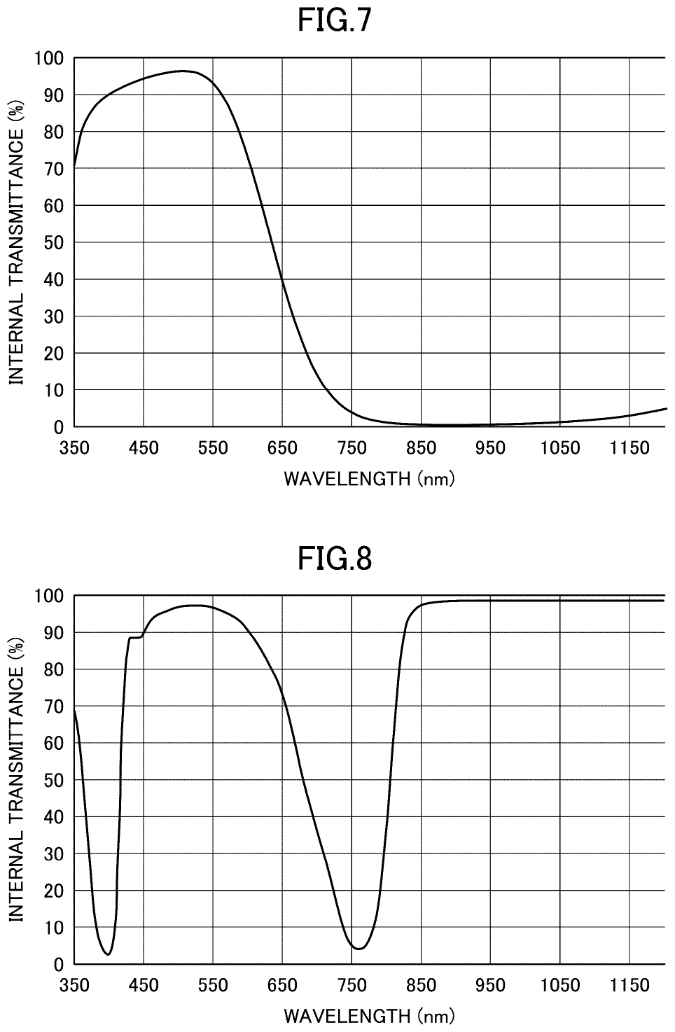

FIG. 7 schematically shows an example of optical properties of the glass substrate 310. In FIG. 7, the horizontal axis represents wavelength, and the vertical axis represents internal transmittance.

In the present application, “internal transmittance (%)” is expressed by a following formula (1):

$$Internal Transmittance ( \% ) = {T}_{( 5 )} / ( 100 - {R}_{( 5 )} ) \times 100. \qquad ( 1 )$$

Here, T₍₅₎ is transmittance (%) at an incidence angle of 5°, and R₍₅₎ is reflectance (%) at an incidence angle of 5°.

As shown in FIG. 7, the glass substrate 310 preferably has spectral characteristics specified as:
(i) an internal transmittance T_{(g)450} at wavelength of 450 nm is 92% or more;
(ii) an average internal transmittance T_{(g)ave1} in a wavelength range of 450 to 600 nm is 90% or more;
(iii) a minimum wavelength λ_{(g)50} at which the internal transmittance is 50% is in a wavelength range of 625 to 650 nm;
(iv) an average internal transmittance T_{(g)ave2} in a wavelength range of 750 to 1000 nm is 2.5% or less; and
(v) a maximum internal transmittance T (g) max in a wavelength range of 1000 to 1200 nm is 7% or less.

### (First Inorganic Film 322, Second Inorganic Film 324, and Third Inorganic Film 326)

The first inorganic film 322 to the third inorganic film 326 are provided to protect the glass substrate 310 from the outside. That is, the glass substrate 310 made of phosphate glass tends to elute when it comes s into contact with moisture in the outside. However, such elution can be significantly prevented by covering the periphery of the glass substrate 310 with the first inorganic film 322 to the third inorganic film 326.

The first inorganic film 322 to the third inorganic film 326 need not necessarily be made of the same material. For example, the first inorganic film 322, the second inorganic film 324, and the third inorganic film 326 may all be made of different materials.

However, it is preferable that the first inorganic film 322 to the third inorganic film 326 are all made of aluminum oxide. This is because the aluminum oxide film serves as an effective barrier against moisture.

Methods of forming the first inorganic film 322 to the third inorganic film 326 are not particularly limited. The first inorganic film 322 to the third inorganic film 326 may be formed by, for example, a sputtering method or a vapor deposition method.

The thicknesses of the first inorganic film 322 to the third inorganic film 326 are not particularly limited. The thicknesses of the first inorganic film 322 to the third inorganic film 326 may be in the range of, for example, 0.1 to 3 μm.

In the present application, when the inorganic film (first inorganic film 322, second inorganic film 324, and third inorganic film 326) has a thickness distribution, the term “thickness of the inorganic film” refers to a minimum thickness.

### (First Antireflection Layer 330 and Second Antireflection Layer 350)

In the present application, the term “antireflection layer” refers to a layer configured to have a maximum reflectance of 45% or less with respect to light having a wavelength between 450 and 1200 nm.

The first antireflection layer 330 is composed of a multilayer film.

The multilayer film may be composed of alternating films of high refractive index films and low refractive index films.

The high refractive index film may selected from, for example, titania and alumina. The low refractive index film may be selected from, for example, silica and magnesium fluoride.

The thickness of the first antireflection layer 330 is not limited thereto, but may be in the range of, for example, 0.1 to 3 μm.

The same applies to the second antireflection layer 350.

As described above, among the films constituting the first antireflection layer 330, the film nearest to the glass substrate 310 may be the first inorganic film 322. Similarly, among the films constituting the second antireflection layer 350, the film nearest to the glass substrate 310 may be the second inorganic film 324.

### (Resin Layer 340)

The resin layer 340 includes dye that absorbs infrared rays.

Such dye may be selected from, for example, a squarylium dye, a phthalocyanine dye, and a cyanine dye.

The resin constituting the resin layer 340 is not particularly limited as long as it is transparent.

The resin may be selected from, for example, polyester resins, acrylic resins, epoxy resins, en-thiol resins, polycarbonate resins, polyether resins, polyarylate resins, polysulfone resins, polyether sulfone resins, polyparaphenylene resins, polyarylene ether phosphine oxide resins, polyamide resins, polyimide resins, polyamideimide resins, polyolefin resins, cyclic olefin resins, polyurethane resins, polystyrene resins, and the like.

The resin is preferably selected from polyimide resin, polycarbonate resin, polyester resin, and acrylic resin from the viewpoint of spectral characteristics, glass transition temperature (Tg), and adhesion of the resin layer 340.

The glass transition temperature (Tg) of the resin is preferably 200° C. or higher from the viewpoint of heat resistance.

The resin layer 340 may contain one type of resin, or two types or more may be mixed and used.

The thickness of the resin layer 340 is 10 μm or less. The thickness of the resin layer 340 is preferably in the range of 0.3 to 10 μm.

The resin layer 340 (i.e., the dye) may have a maximum absorption wavelength in the range of 650 nm to 850 nm. For example, the squarylium dye described above may have a maximum absorption wavelength of 752 nm, and the cyanine dye may have a maximum absorption wavelength of 773 nm.

Furthermore, the resin layer 340 may have a dye that absorbs light in the ultraviolet region. Such a dye may be, for example, a merocyanine dye (maximum absorption wavelength of 397 nm).

By providing the resin layer 340, the internal transmittance of the infrared region can be further reduced.

FIG. 8 schematically shows an example of the absorption spectrum of the resin layer 340 (precisely, the dye contained in the resin layer 340).

In FIG. 8, the horizontal axis represents the wavelength, and the vertical axis represents the internal transmittance.

The resin layer 340 includes a merocyanine dye, a cyanine dye, and a squarylium dye as the dyes.

As shown in FIG. 8, in the present example, the resin layer 340 exhibits a large absorption in a region of approximately 400 nm wavelength and a region of approximately 750 nm wavelength.

Therefore, when the resin layer 340 is combined with the glass substrate 310 made of dye-containing phosphate glass, the internal transmittance in the infrared region can be further suppressed compared with the case where only the glass substrate 310 is used. In this case, the internal transmittance in the ultraviolet region can also be sufficiently suppressed.

### (First Optical Filter 100)

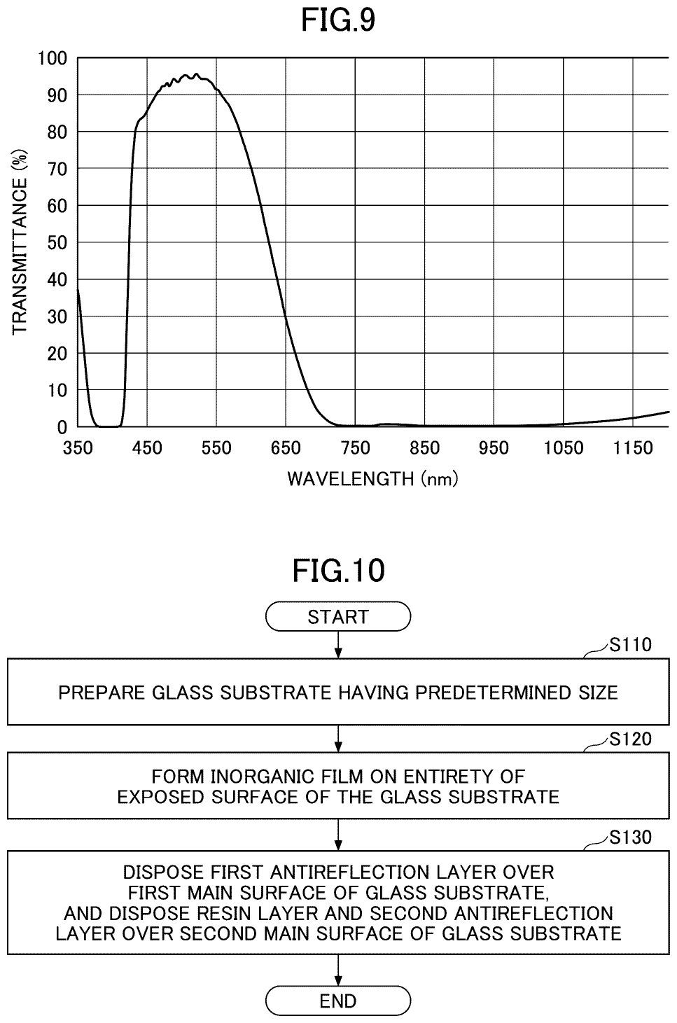

FIG. 9 schematically shows an example of the optical properties of the first optical filter 100. In FIG. 9, the horizontal axis represents wavelength and the vertical axis represents transmittance.

FIG. 9 shows a change in transmittance at an incidence angle of 0°. However, in the case of the first optical filter 100, the optical properties do not change much at an incidence angle of 50°.

As shown in FIG. 9, the first optical filter 100 can obtain spectral characteristics specified as:
(I) a transmittance T₍ₜ₎₄₅₀ at a wavelength of 450 nm is 80% or more at incidence angles of 0° and 50°;
(II) an average transmittance T₍ₜ₎ₐᵥₑ₁ in a wavelength range of 450 to 600 nm is 78% or more at incidence angles of 0° and 50°;
(III) a maximum transmittance T₍ₜ₎ₘₐₓ₁ in a wavelength range of 450 to 600 nm is 85% or more at incidence angles of 0° and 50°;
(IV) a minimum wavelength A₍ₜ₎₅₀ at which a transmittance is 50% is in a wavelength range of 600 to 640 nm at incidence angles of 0° and 50°;
(V) an average transmittance T₍ₜ₎ₐᵥₑ₂ in a wavelength range of 750 to 1200 nm is 2.0% or less at incidence angles of 0° and 50°; and
(VI) a maximum transmittance T₍ₜ₎ₘₐₓ₂ in a wavelength range of 1000 to 1200 nm is 15% or less at incidence angles of 0° and 50°.

Further, when light is incident from the direction of the first main surface 312 of the glass substrate 310, the first optical filter 100 preferably has spectral characteristics:
(VII) the maximum reflectance R₍ₜ₎ₘₐₓ₁ at the wavelength range of 450 to 700 nm is 7% or less at incidence angles of 5° and 50°; and
(VIII) the maximum reflectance R₍ₜ₎ₘₐₓ₂ at the wavelength range of 700 to 1200 nm is 45% or less at incidence angles of 5° and 50°.

### (Method of Manufacturing Optical Filter According to One Embodiment of the Invention)

Next, an example of a method of manufacturing an optical filter according to one embodiment of the present invention will be described with reference to FIG. 10.

As shown in FIG. 10, a method of manufacturing an optical filter (hereinafter, referred to as “first method”) according to one embodiment of the present invention includes:
preparing a glass substrate having a predetermined size (step S110);
forming an inorganic film on an entirety of exposed surface of the glass substrate (step S120); and
disposing a first antireflection layer on a first main surface of the glass substrate and disposing a resin layer and a second antireflection layer on a second main surface of the glass substrate (step S130).

Hereinafter, each step will be described.

Here, a method of manufacturing the third optical filter 300 will be described as an example. Accordingly, reference numerals shown in FIG. 4 will be used to denote each member.

### (Step S110)

First, a glass substrate is prepared. As described above, the glass substrate 310 has a first main surface 312, a second main surface 314, and an end surface 316 and is composed of phosphate glass containing an absorbent.

The glass substrate 310 is preferably cut in advance to a size required for an optical filter. This is because, when the glass substrate 310 is cut after the inorganic film is formed in the next step S120, the end surface 316 which is not covered with the inorganic film may be exposed.

### (Step S120)

Next, the first inorganic film 322 is provided on the first main surface 312 of the glass substrate 310, the second inorganic film 324 is provided on the second main surface 314, and the third inorganic film 326 is provided on the end surface 316.

The first inorganic film 322 to the third inorganic film 326 (hereinafter, also collectively referred to as “inorganic films”) may be made of the same material or different materials. For example, all of the inorganic films may be made of alumina.

The method of forming the inorganic film is not particularly limited. The inorganic film may be formed by, for example, a vapor deposition method or a sputtering method.

When the inorganic films of the same material are formed, the first treatment for forming the first inorganic film 322 on the first main surface 312, the second treatment for forming the second inorganic film 324 on the second main surface 314, and the third treatment for forming the third inorganic film 326 on the end surface 316 may be performed in random order.

However, as described above, when the end surface 316 of the glass substrate 310 has a portion inclined with respect to the first main surface 312 or the second main surface 314, the third inorganic film 326 can be formed on the end surface 316 by the first treatment and/or the second treatment. In this case, the third treatment can be omitted, and the process can be simplified.

The inorganic film is formed on the entirety of the exposed surface of the glass substrate 310 by the step S120.

### (Step S130)

Thereafter, the members necessary for the first optical filter 100 are sequentially formed on the glass substrate 310.

Specifically, the first antireflection layer 330 is provided on the first inorganic film 322, and the resin layer 340 and the second antireflection layer 350 are provided on the second inorganic film 324.

As described above, the first antireflection layer 330 is composed of a plurality of films. The first antireflection layer 330 may be formed by alternately forming a high refractive index film and a low refractive index film.

The method of forming the first antireflection layer 330 is not particularly limited. For example, a general film forming method such as a sputtering method may be used.

The resin layer 340 is formed from a resin solution containing dye.

The resin solution may be prepared by dissolving a dye in a solution containing a resin and an organic solvent. The dye may include an infrared absorbing dye and an ultraviolet absorbing dye as described above.

Next, a resin solution is coated on the second inorganic film 324 by a coating method such as a spin coating method. The coated film is then dried to form the resin layer 340.

The second antireflection layer 350 can be formed by the same method as the first antireflection layer 330.

The third optical filter 300 can be manufactured by the above steps.

In the foregoing description, the method of manufacturing the third optical filter 300 has been described by way of example. However, it is obvious to those skilled in the art that the optical filter according to another embodiment of the present invention can be manufactured by the same method.

For example, in the case of manufacturing the second optical filter 200, the step of disposing the resin layer on the first inorganic film may be omitted in the first method, and the second antireflection layer may be directly disposed on the first inorganic film.

In addition, various other modifications can be carried out.

The optical filter according to one embodiment of the present invention can be applied to an imaging apparatus such as a digital still camera. Such an imaging apparatus can provide good color reproducibility.

An imaging apparatus including an optical filter according to an embodiment of the present invention further includes a solid-state imaging device and an imaging lens, and the optical filter may be disposed between the imaging lens and the solid-state imaging device, for example. The optical filter according to an embodiment of the present invention may be directly attached to the solid-state imaging device and/or the imaging lens of the imaging apparatus, for example, via an adhesive layer.

### EXAMPLE

In order to evaluate the durability of a phosphate glass substrate, the following preliminary experiments were conducted.

### (Experiment 1)

A glass substrate in which an entirety of an exposed surface was covered with an inorganic film was prepared by the following method.

First, a glass plate having a length of 76 mm×width of 76 mm×thickness of 0.28 mm was prepared. Phosphate glass having the composition shown in “Glass A” in Table 1 below was used as the glass plate.

TABLE 1

| Composition | | |
|---|---|---|
| (mass %) | Glass A | Glass B |
| P₂O₅ | 68 | 70 |
| Al₂O₃ | 11 | 13 |
| Li₂O | — | 1 |
| Na₂O | 3 | 1 |
| K₂O | 6 | 1 |
| Rb₂O | — | — |
| Cs₂O | — | — |
| CaO | — | — |
| SrO | — | — |
| MgO | 4 | 1 |
| BaO | — | 3 |
| ZnO | — | 5 |
| CuO | 8 | 5 |
| F | — | — |
| Total | 100 | 100 |

The optical characteristics of the glass plate used are shown in FIG. 7. Various parameters calculated from the measured optical characteristics are shown in the column of “Glass A” in Table 2 below.

TABLE 2

| Optical Parameters | Glass A | Glass B |
|---|---|---|
| Internal Transmittance T_{(g)450} | 94.6 | 95.7 |
| at Wavelength of 450 nm (%) | | |
| Average Internal Transmittance T_{(g)ave1} | 92.1 | 92.4 |
| in Wavelength Range of 450-600 nm (%) | | |
| Minimum Wavelength λ_{(g)50} | 634 | 629 |
| at which Internal Transmittance is 50% (nm) | | |
| Average Internal Transmittance T_{(g)ave2} | 0.8 | 1.9 |
| in Wavelength Range of 750-1000 nm (%) | | |
| Maximum Internal Transmittance T_{(g)max} | 2.2 | 6.4 |
| in Wavelength Range of 1000-1200 nm (%) | | |

Next, a glass plate was cut in a full cut by the blade dicing method, and a glass substrate having a length of 20 mm×width of 20 mm×thickness of 0.28 mm was prepared.

Above-mentioned FIG. 5 schematically shows the form of the cut surface of the obtained glass substrate (hereinafter, referred to as “glass substrate 1”).

As shown in FIG. 5, the glass substrate 1 has four end surfaces 316 inclined from the first main surface 312 toward the second main surface 314. The inclination angle α (0≤α<90°) was 1°.

Next, a first alumina film was formed on the first main surface 312 of the glass substrate 1 by vapor deposition. The thickness of the first alumina film was aimed at 143 nm.

Next, a second alumina film was formed on the second main surface 314 of the glass substrate 1. The thickness of the second alumina film was aimed at 143 nm.

After the deposition of the first main surface 312 and the second main surface 314, the end surface 316 of the glass substrate 1 was observed using a scanning electron microscope (Fe-SEM). As a result, it was confirmed that the end surface 316 of the glass substrate 1 was coated with an alumina film.

This is considered to be because, as described above, the cut surface of the glass substrate 1 is not a vertical plane but extends from the first main surface 312 to the second main surface 314 at an inclination angle α. That is, it is considered to be because, during the deposition on the second main surface 314, the deposition material also went around to the end surface 316 side, and the deposition material was deposited there.

Next, a high-temperature high-humidity test was conducted for 200 hours using the glass substrate 1 coated with the alumina film. The test temperature was 85° C., and the relative humidity was 85%.

After the test, the glass substrate 1 was removed and the state was evaluated. As a result, no abnormality was observed on the first main surface 312 and the second main surface 314 of the glass substrate 1. It was also found that the elution of the glass was suppressed to 1 mm or less from the surface at the end surface 316.

### (Experiment 2)

The same experiment as Experiment 1 was carried out.

However, in Experiment 2, a glass plate different from that in Experiment 1 was cut to prepare a glass substrate.

Phosphate glass having the composition shown in “Glass B” in Table 1 was used for the glass plate. The thickness of the glass plate was 0.35 mm.

Various parameters calculated from the optical characteristics of the glass plate are shown in the column of “Glass B” in the aforementioned Table 2.

Thereafter, a glass substrate coated with an alumina film (hereinafter, referred to as “glass substrate 2”) was produced by the same method as in the case of Experiment 1.

Next, a high-temperature high-humidity test was conducted using the glass substrate 2 coated with the alumina film.

After the test, the glass substrate 2 was removed and the state was evaluated. As a result, no abnormality was observed on the first and second main surfaces of the glass substrate 2. It was also found that the elution of the glass was suppressed to 1 mm or less from the surface even at the end surface.

### (Experiment 3)

A glass substrate in which the entirety of the exposed surface was covered with an inorganic film was prepared by the following method.

A glass plate having a length of 76 mm×width of 76 mm×thickness of 0.28 mm was prepared.

Phosphate glass having the composition shown in “Glass A” in Table 1 below was used as the glass plate.

Next, a first alumina film was formed on the first main surface of the glass plate by vapor deposition. The thickness of the first alumina film was aimed at 143 nm.

Next, using a blade having a tapered tip, the glass plate was bevel-cut from the side of the second main surface to a depth of 0.12 mm. Further, by the same blade dicing method as in Experiment 1, the remaining thickness of the glass plate was half-cut to obtain a glass substrate having a length of 20 mm×width of 20 mm×thickness of 0.28 mm.

FIG. 6 schematically shows the shape of the cut surface of the obtained glass substrate (hereinafter, referred to as “glass substrate 3”).

As shown in FIG. 6, the end surface 316 of the glass substrate 3 has a first portion 317a extending perpendicularly from the first main surface 312 toward the second main surface 314, and a second portion 317b extending at an angle β with respect to the normal line of the first main surface 312.

The height of the first portion 317a (a length along the thickness direction of the glass substrate 3) was 0.16 mm, and the height of the second portion 317b (length along the thickness direction of the glass substrate 3) was 0.12 mm. The inclination angle β was 45°.

Next, a second alumina film was formed on the second main surface 314 of the glass substrate 3 by vapor deposition. The thickness of the second alumina film was aimed at 143 nm.

After the deposition of the second alumina film, the end surface 316 of the glass substrate 3 was observed using a scanning electron microscope (Fe-SEM). As a result, it was confirmed that both of the first portion 317a and the second portion 317b were coated with an alumina film in the end surface 316 of the glass substrate 3.

Next, a high-temperature high-humidity test was conducted using the glass substrate 3 coated with the alumina film.

After the test, the glass substrate 3 was removed and the state was evaluated. As a result, no abnormality was observed on the first main surface 312 and the second main surface 314 of the glass substrate 3. It was also found that the elution of the glass was suppressed to 0.8 mm or less from the surface at the end surface 316.

### (Experiment 4)

A glass substrate was prepared by a following method.

A glass plate having a length of 76 mm×width of 76 mm×thickness of 0.28 mm was prepared. Phosphate glass having the composition shown in “Glass A” in Table 1 below was used as the glass plate.

Next, an alumina film was formed on the both main surfaces of the glass plate by vapor deposition. The thickness of each of the alumina film was aimed at 143 nm.

Next, a glass plate was cut in a full cut by the blade dicing method, and a glass substrate having a length of 20 mm×width of 20 mm×thickness of 0.28 mm (hereinafter, referred to as “glass substrate 4” was prepared.

After cutting, the end surface of the glass substrate 4 was observed using a scanning electron microscope (Fe-SEM). As a result, it was found that the alumina film was not formed on the end surface of the glass substrate 4.

Next, a high-temperature high-humidity test was performed using the glass substrate 4.

After the test, the glass substrate 4 was taken out and the state was evaluated. As a result, in the glass substrate 4, glass elution occurred in a region exceeding 1 mm from the surface at the end surface.

Thus, when phosphate glass was used as the glass substrate, it was found that glass elution occurred due to moisture from the outside and that such glass elution was suppressed by covering the entire exposed surface of the glass substrate with an alumina film.

### EXAMPLES

Examples of the present invention will be described below. In the following description, Examples 1 and 2 are examples.

### Example 1

An optical filter was prepared by the following method.

A glass substrate in which an entirety of an exposed surface was coated with an alumina film was prepared by the same method as that described in Experiment 1. Hereinafter, this glass substrate will be referred to as “coated glass substrate A”. The alumina film provided on the first main surface of the coated glass substrate A will be referred to as “first alumina film”, the alumina film provided on the second main surface will be referred to as “second alumina film”, and the alumina film provided on the end surface will be referred to as “third alumina film”.

Next, a first antireflection layer was formed on the first alumina film of the coated glass substrate A by vapor deposition. The first antireflection layer was an alternating film of a silica film and a titania film. The total thickness of the first antireflection layer was 200 nm.

Table 3 below shows the configuration of the first antireflection layer.

TABLE 3

| Film No. | Material | Thickness (nm) |
|---|---|---|
| 1 | SiO₂ | 109.08 |
| 2 | TiO₂ | 32.78 |
| 3 | SiO₂ | 13.23 |
| 4 | TiO₂ | 82.18 |
| 5 | SiO₂ | 30.05 |
| 6 | TiO₂ | 25.12 |
| 7 | SiO₂ | 89.55 |
| 8 | TiO₂ | 9 |
| 9 | SiO₂ | 105.5 |
| 10 | TiO₂ | 17.77 |
| 11 | SiO₂ | 62.77 |
| 12 | TiO₂ | 26.43 |
| 13 | SiO₂ | 52.54 |
| 14 | TiO₂ | 15.39 |
| 15 | SiO₂ | 105 |

In Table 3, the first film is the film closest to the first main surface of the glass substrate A, and the second film, the third film, . . . , and the 15th film are arranged in the order of proximity from the first main surface.

Next, a liquid for the resin layer was prepared. The liquid for the resin layer was prepared as follows.

First, polyimide varnish C3G30G (manufactured by Mitsubishi Gas Chemical Company, Inc.) was diluted with cyclohexanone and Y-butyrolactone so that the resin solid content was 8.5 wt %.

Compound A, Compound B, and Compound C were added as dyes to the diluted solution to prepare a liquid for a resin layer. The amounts of Compound A, Compound B, and Compound C added were 2.33 mass %, 6.08 mass %, and 2.56 mass %, respectively, with respect to the resin.

The specifications for Compound A, Compound B, and Compound C are summarized in Table 4 below.

TABLE 4

| | Maximum Absorption | |
|---|---|---|
| Compound | Wavelength | Dye Classification |
| A | 752 nm | Squarylium Dye |
| B | 397 nm | Merocyanine Dye |
| C | 773 nm | Cyanine Dye |

Compound A, Compound B, and Compound C each have the following general formula.

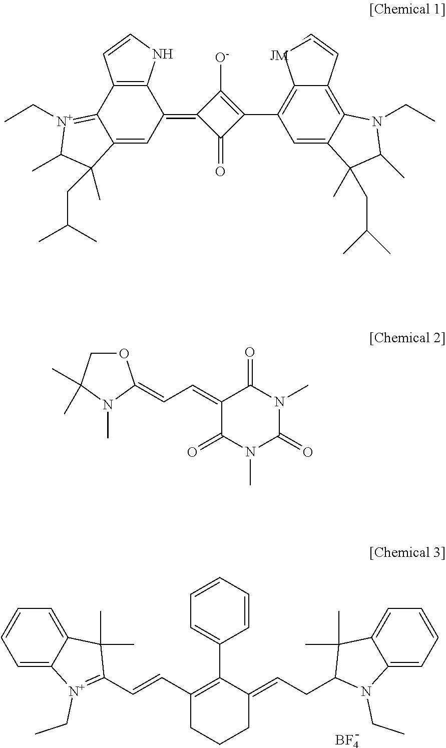

Next, a resin layer liquid was spin-coated on the second alumina film of the coated glass substrate A. The target thickness was 1 μm.

Next, the resin layer liquid was dried to form a resin layer.

This resin layer has optical properties as shown in FIG. 8.

Next, a second antireflection layer was formed on the resin layer. The second antireflection layer had the same structure as that of the first antireflection layer and was formed by vapor deposition.

Thus, an optical filter (hereinafter referred to as “optical filter 1”) was obtained.

### Example 2

An optical filter was prepared by the same method as in Example 1.

However, in Example 2, a glass substrate in which the entire exposed surface was coated with an alumina film was prepared by the same method as in the above-described Experiment 2. Hereinafter, this glass substrate is referred to as “coated glass substrate B”.

Thereafter, optical an filter was manufactured by the same process as in Example 1.

Hereinafter, the obtained optical filter is referred to as “optical filter 2”.

### (Evaluation)

The following evaluations were performed using each optical filter.

### (Evaluation of Durability)

A high-temperature, high-humidity test was performed under the aforementioned conditions using the optical filter 1 and the optical filter 2.

As a result of observation after the test, the optical filter 1 and the optical filter 2 hardly showed elution on the end surface of the glass substrate.

### (Evaluation of Optical Properties)

The optical properties were evaluated using each optical filter. For the measurement, an ultraviolet-visible near-infrared spectrophotometer (UH4150, manufactured by Hitachi High-Tech Corporation) was used.

For the measurement of transmittance, light was incident on each optical filter from the side of the first antireflection layer. The incidence angles were 0° and 50°. Additionally, for the measurement of reflectance, light was incident on each optical filter from the side of the first antireflection layer at incidence angles of 5° and 50°.

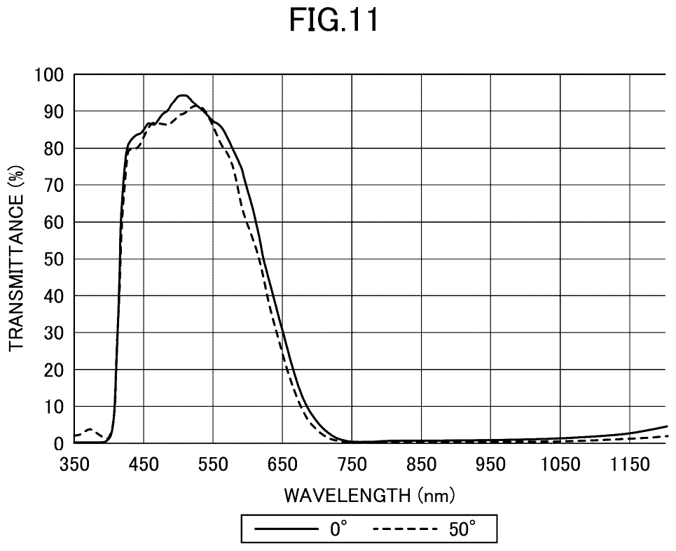

FIG. 11 shows one example of a transmittance profile obtained in the optical filter 1. In FIG. 11, the horizontal axis represents the wavelength, and the vertical axis represents the transmittance. FIG. 11 shows the results at incidence angles of 0° and 50°.

As shown in FIG. 11, it can be seen that in the optical filter 1, the influence of the incidence angle on the transmittance profile is hardly observed. That is, in the visible light region, a high transmittance was obtained regardless of the incidence angle. Moreover, even if the incidence angle changed, the region where the transmittance rapidly decreased hardly changed. Moreover, it was found that a low transmittance was shown in the wavelength region exceeding 1000 nm regardless of the incidence angle.

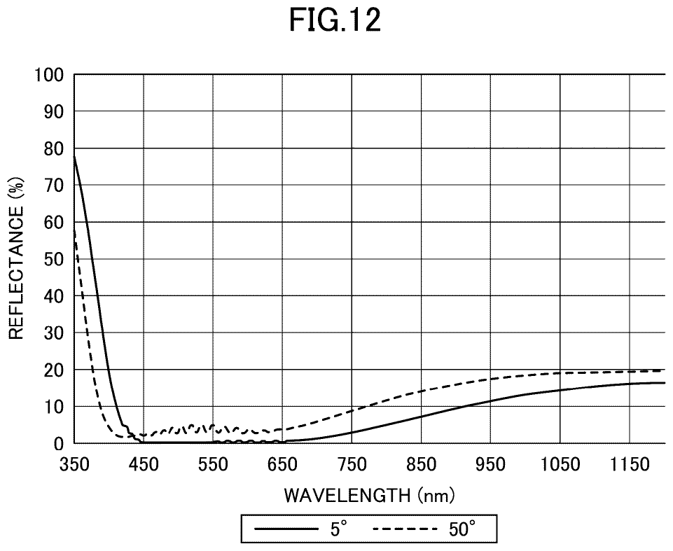

FIG. 12 shows an example of a reflectance profile obtained in the optical filter 1. In FIG. 12, the horizontal axis represents the wavelength and the vertical axis represents the reflectance. FIG. 12 shows the results at incidence angles of 5° and 50° together.

As shown in FIG. 12, it can be seen that the effect of incidence angle on the reflectance profile is hardly observed in the optical filter 1.

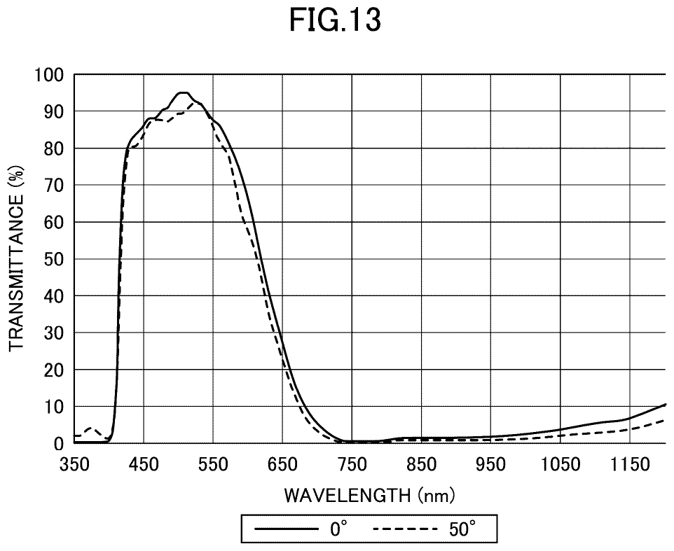

FIG. 13 shows an example of the transmittance profile obtained in the optical filter 2. In FIG. 13, the horizontal axis represents the wavelength and the vertical axis represents the transmittance. FIG. 13 shows the results at incidence angles of 0° and 50° together.

As shown in FIG. 13, the optical filter 2 obtained the same result as the optical filter 1. That is, a high transmittance was obtained in the visible light region regardless of the incidence angle. In addition, even if the incidence angle changed, the region in which the transmittance decreased abruptly did not change. Moreover, it was found that a low transmittance was shown in the region over 1000 nm wavelength regardless of the incidence angle.

The parameters related to the transmittance profiles measured in the optical filter 1 and the optical filter 2 are summarized in Table 5 below.

TABLE 5

| | Optical Filter 1 | | Optical Filter 2 | |
|---|---|---|---|---|
| | Incidence Angle | | Incidence Angle | |
| | (°) | | (°) | |
| Optical Parameters | 0 | 50 | 0 | 50 |
| Transmittance T₍ₜ₎₄₅₀ | 85.4 | 83.4 | 86.7 | 84.5 |
| at Wavelength of 450 nm (%) | | | | |
| Average Transmittance T₍ₜ₎ₐᵥₑ₁ | 87.1 | 83.5 | 87.3 | 83.8 |
| in Wavelength Range | | | | |
| of 450-600 nm (%) | | | | |
| Maximum Transmittance T₍ₜ₎ₘₐₓ₁ | 94.6 | 91.5 | 95.4 | 92.5 |
| in Wavelength Range | | | | |
| of 450-600 nm (%) | | | | |
| Minimum Wavelength λ₍ₜ₎₅₀ | 623 | 616 | 623 | 616 |
| at which Internal Transmittance | | | | |
| is 50% (nm) | | | | |
| Average Transmittance T₍ₜ₎ₐᵥₑ₂ | 1.1 | 0.4 | 3.1 | 1.7 |
| in Wavelength Range | | | | |
| of 750-1200 nm (%) | | | | |
| Maximum Transmittance T₍ₜ₎ₘₐₓ₂ | 4.2 | 1.8 | 10.3 | 6.1 |
| in Wavelength Range | | | | |
| of 1000-1200 nm (%) | | | | |

The parameters related to the reflectance profiles measured in the optical filter 1 and the optical filter 2 are summarized in Table 6 below.

TABLE 6

| | Optical Filter 1 | | Optical Filter 2 | |
|---|---|---|---|---|
| | Incident Angle | | Incident Angle | |
| | (°) | | (°) | |
| Optical Parameters | 5 | 50 | 5 | 50 |
| Maximum Reflectance R₍ₜ₎ₘₐₓ₁ | 4.0 | 6.2 | 4.9 | 6.6 |
| in Wavelength Range | | | | |
| of 450-700 nm (%) | | | | |
| Maximum Reflectance R₍ₜ₎ₘₐₓ₂ | 9.0 | 20.8 | 9.3 | 20.9 |
| in Wavelength Range | | | | |
| of 700-1200 nm (%) | | | | |

As described above, it was confirmed that the optical characteristics of the optical filter 1 and the optical filter 2 hardly changed even if the incidence angle changed. It was also confirmed that the optical filter 1 and the optical filter 2 sufficiently shielded infrared rays.

### (Aspects of the Present Invention)

The present invention includes the following aspects.

### (Aspect 1)

An optical filter including:
a glass substrate having a first main surface, a second main surface opposite the first main surface, and an end surface connecting the first and second main surfaces, the glass substrate being a phosphate glass containing an absorbent; and
a first antireflection layer disposed directly or indirectly on the first main surface of the glass substrate,
wherein the first main surface of the glass substrate is coated with a first inorganic film, and a second inorganic film is provided directly or indirectly on the second main surface of the glass substrate, with the end surface being coated with a third inorganic film, and
wherein the first inorganic film is a film that is closest to the glass substrate among films constituting the first antireflection layer, or a film that is different from a film composed of a plurality of films constituting the first antireflection layer.

### (Aspect 2)

The optical filter according to aspect 1, wherein the second inorganic film directly covers the second main surface of the glass substrate.

### (Aspect 3)

The optical filter according to aspect 1 or 2, wherein a resin layer including a dye is disposed directly or indirectly on the second main surface of the glass substrate, and wherein the resin layer has a maximum absorption wavelength in a range of 650 to 850 nm.

### (Aspect 4)

The optical filter according to aspect 3, wherein the resin layer is disposed directly or indirectly on the second inorganic film.

### (Aspect 5)

The optical filter according to any one of aspects 1 to 4, wherein a second antireflection layer is disposed directly or indirectly on the second main surface of the glass substrate, and wherein the second inorganic film is a film that is closest to the glass substrate among films constituting the second antireflection layer, or a film that is different from the film composed of the plurality of films constituting the second antireflection layer.

### (Aspect 6)

The optical filter according to aspect 5, wherein:
the second main surface of the glass substrate is coated with a resin layer including a dye;
the resin layer has a maximum absorption wavelength in a range of 650 to 850 nm; and
the second antireflection layer is disposed directly or indirectly on the resin layer.

### (Aspect 7)

The optical filter according to any one of aspects 1 to 6, wherein the first inorganic film is a film different from the film composed of the plurality of films constituting the first antireflection layer.

### (Aspect 8)

The optical filter according to aspect 1 or 2, wherein the first inorganic film, the second inorganic film, and the third inorganic film are made of a same material.

### (Aspect 9)

The optical filter according to aspect 8, wherein the first inorganic film, the second inorganic film, and the third inorganic film are aluminum oxide films.

### (Aspect 10)

The optical filter according to any one of aspects 1 to 9, wherein the end surface of the glass substrate has a portion inclined with respect to a normal to the first main surface.

### (Aspect 11)

The optical filter according to any one of aspects 1 to 10, wherein:
when transmittance (%) at an incidence angle of 5° is referred to as T₍₅₎ and reflectance (%) at an incidence angle of 5° is referred to as R₍₅₎, internal transmittance of the glass substrate is expressed by a following formula:

$$Internal Transmittance ( \% ) = {T}_{( 5 )} / ( 100 - {R}_{( 5 )} ) \times 100 , and$$

the glass substrate has spectral characteristics specified as:
(i) an internal transmittance T_{(g)450} at a wavelength of 450 nm is 92% or more;
(ii) an average internal transmittance T_{(g)ave1} in a wavelength range of 450 to 600 nm is 90% or more;
(iii) a minimum wavelength λ_{(g)50} at which the internal transmittance is 50% in a wavelength range of 625 to 650 nm;
(iv) an average internal transmittance T_{(g)ave2} in a wavelength range of 750 to 1000 nm is 2.5% or less; and
(v) a maximum internal transmittance T_{(g)max} in a wavelength range of 1000 to 1200 nm is 7% or less.

### (Aspect 12)

The optical filter according to any one of aspects 1 to 11, wherein the glass substrate includes, in a percentage by mass on an oxide basis:
50 to 80% of P₂O₅;
5 to 20% of Al₂O₃;
4 to 20% of CuO;
0.5 to 15% of R(1) ₂O, wherein R(1) is at least one component selected from a group consisting of Li, Na, K, Rb, and Cs; and
0 to 15% of R(2)O, wherein R(2) is at least one component selected from a group consisting of Ca, Mg, Ba, Sr, and Zn.

### (Aspect 13)

The optical filter according to any one of aspects 1 to 12, wherein the optical filter has spectral characteristics specified as:
(I) a transmittance T₍ₜ₎₄₅₀ at a wavelength of 450 nm is 80% or more at incidence angles of 0° and 500;
(II) an average transmittance T₍ₜ₎ₐᵥₑ₁ in a wavelength range of 450 to 600 nm is 78% or more at incidence angles of 0° and 50°;
(III) a maximum transmittance T₍ₜ₎ₘₐₓ₁ in the wavelength range of 450 to 600 nm is 85% or more at incidence angles of 0° and 50°;
(IV) a minimum wavelength λ₍ₜ₎₅₀ at which the transmittance is 50% is in a range of 600 to 650 nm at incidence angles of 0° and 50°;
(V) an average transmittance T₍ₜ₎ₐᵥₑ₂ in a wavelength range of 750 to 1200 nm is 4.0% or less at incidence angles of 0° and 50°; and
(VI) a maximum transmittance T₍ₜ₎ₘₐₓ₂ in a wavelength range of 1000 to 1200 nm is 15% or less at incidence angles of 0° and 50°.

### (Aspect 14)

The optical filter according to according to any one of aspects 1 to 13, wherein when light is incident from a direction of the first main surface of the glass substrate, the optical filter has spectral characteristics specified as:
(VII) a maximum reflectance R₍ₜ₎ₘₐₓ₁ in a wavelength range of 450 to 700 nm is 7% or less at incidence angles of 5° and 50°; and
(VIII) a maximum reflectance R₍ₜ₎ₘₐₓ₂ in a wavelength range of 700 to 1200 nm is 45% or less at incidence angles of 0° and 50°.

### (Aspect 15)

An imaging apparatus having the optical filter of any one of aspects 1 to 14.

What is claimed is:

1. An optical filter comprising:
a glass substrate having a first main surface, a second main surface opposite the first main surface, and an end surface connecting the first and second main surfaces, the glass substrate being a phosphate glass containing an absorbent; and
a first antireflection layer disposed directly or indirectly on the first main surface of the glass substrate,
wherein the first main surface of the glass substrate is coated with a first inorganic film, and a second inorganic film is provided directly or indirectly on the second main surface of the glass substrate, with the end surface being coated with a third inorganic film, and
wherein the first inorganic film is a film that is closest to the glass substrate among films constituting the first antireflection layer, or a film that is different from a film composed of a plurality of films constituting the first antireflection layer.

2. The optical filter according to claim 1, wherein the second inorganic film directly covers the second main surface of the glass substrate.

3. The optical filter according to claim 1, wherein a resin layer including a dye is disposed directly or indirectly on the second main surface of the glass substrate, and wherein the resin layer has a maximum absorption wavelength in a range of 650 to 850 nm.

4. The optical filter according to claim 3, wherein the resin layer is disposed directly or indirectly on the second inorganic film.

5. The optical filter according to claim 1, wherein a second antireflection layer is disposed directly or indirectly on the second main surface of the glass substrate, and wherein the second inorganic film is a film that is closest to the glass substrate among films constituting the second antireflection layer, or a film that is different from the film composed of the plurality of films constituting the second antireflection layer.

6. The optical filter according to claim 5, wherein:
the second main surface of the glass substrate is coated with a resin layer including a dye;
the resin layer has a maximum absorption wavelength in a range of 650 to 850 nm; and
the second antireflection layer is disposed directly or indirectly on the resin layer.

7. The optical filter according to claim 1, wherein the first inorganic film is a film different from the film composed of the plurality of films constituting the first antireflection layer.

8. The optical filter according to claim 1, wherein the first inorganic film, the second inorganic film, and the third inorganic film are made of a same material.

9. The optical filter according to claim 8, wherein the first inorganic film, the second inorganic film, and the third inorganic film are aluminum oxide films.

10. The optical filter according to claim 1, wherein the end surface of the glass substrate has a portion inclined with respect to a normal to the first main surface.

11. The optical filter according to claim 1, wherein:
when transmittance (%) at an incidence angle of 5° is referred to as T₍₅₎ and reflectance (%) at an incidence angle of 5° is referred to as R₍₅₎, internal transmittance of the glass substrate is expressed by a following formula:
$$Internal Transmittance ( \% ) = {T}_{( 5 )} / ( 100 - {R}_{( 5 )} ) \times 100 , and$$
the glass substrate has spectral characteristics specified as:
(i) an internal transmittance T_{(g)450} at a wavelength of 450 nm is 92% or more;
(ii) an average internal transmittance T_{(g)ave1} in a wavelength range of 450 to 600 nm is 90% or more;
(iii) a minimum wavelength λ_{(g)50} at which the internal transmittance is 50% in a wavelength range of 625 to 650 nm;
(iv) an average internal transmittance T_{(g)ave2} in a wavelength range of 750 to 1000 nm is 2.5% or less; and
(v) a maximum internal transmittance T (g) max in a wavelength range of 1000 to 1200 nm is 7% or less.

12. The optical filter according to claim 1, wherein the glass substrate includes, in a percentage by mass on an oxide basis:
50 to 80% of P₂O₅;
5 to 20% of Al₂O₃;
4 to 20% of CuO;
0.5 to 15% of R(1) ₂O, wherein R(1) is at least one component selected from a group consisting of Li, Na, K, Rb, and Cs; and
0 to 15% of R(2)O, wherein R(2) is at least one component selected from a group consisting of Ca, Mg, Ba, Sr, and Zn.

13. The optical filter according to claim 1, wherein the optical filter has spectral characteristics specified as:
(I) a transmittance T₍ₜ₎₄₅₀ at a wavelength of 450 nm is 80% or more at incidence angles of 0° and 50°;
(II) an average transmittance T₍ₜ₎ₐᵥₑ₁ in a wavelength range of 450 to 600 nm is 78% or more at incidence angles of 0° and 50°;
(III) a maximum transmittance T₍ₜ₎ₘₐₓ₁ in the wavelength range of 450 to 600 nm is 85% or more at incidence angles of 0° and 50°;
(IV) a minimum wavelength λ₍ₜ₎₅₀ at which the transmittance is 50% is in a range of 600 to 650 nm at incidence angles of 0° and 50°;
(V) an average transmittance T₍ₜ₎ₐᵥₑ₂ in a wavelength range of 750 to 1200 nm is 4.0% or less at incidence angles of 0° and 50°; and
(VI) a maximum transmittance T₍ₜ₎ₘₐₓ₂ in a wavelength range of 1000 to 1200 nm is 15% or less at incidence angles of 0° and 50°.

14. The optical filter according to claim 1, wherein when light is incident from a direction of the first main surface of the glass substrate, the optical filter has spectral characteristics specified as:
(VII) a maximum reflectance R₍ₜ₎ₘₐₓ₁ in a wavelength range of 450 to 700 nm is 7% or less at incidence angles of 5° and 50°; and
(VIII) a maximum reflectance R₍ₜ₎ₘₐₓ₂ in a wavelength range of 700 to 1200 nm is 45% or less at incidence angles of 0° and 50°.

15. An imaging apparatus having the optical filter of claim 1.
